(19) United States
(12) Patent Application Publication
(10) Pub. No.: US 2004/0175543 A1
(43) Pub. Date: Sep. 9, 2004

(54) Nonslip thermoplastic part and method for the production thereof

(76) Inventor: Alfonso Perez Carballo, Madrid (ES)

Correspondence Address: NIXON PEABODY, LLP, 401 9TH STREET, NW, SUITE 900, WASHINGTON, DC, 20004-2128, US

(21) Appl. No.: 10/275,745

(22) PCT Filed: May 9, 2001
(86) PCT No.: PCT/ES01/00180

(30) Foreign Application Priority Data
May 9, 2000 (ES) U 0001238

(51) Int. Cl. B32B 1/00

(52) U.S. Cl. 428/143; 428/157

(57) ABSTRACT

A moulded piece of thermoplastic elastomer material, in particular, a homopolymer with polypropylene load and rubber of extremely low hardness, usable as a label, publicity support or similar, with reduced thickness and generally flat, having a smooth face while on the opposite face presents an elevated perimeter border (subdivided or not into individual projections), and on the interior of said border a central surface portion. Lowered with respect to said border, said central portion intended to receive a corresponding ornamentation such as labelling (silkscreen marking, tampography, etc.) or laminar accessory (sticker or similar) without eliminating because of this the non-slipping properties of the piece; and a method for the production of said piece, which consists of a submarine injection moulding, without use of rollers, of cold casting, that allows the piece to be formed preventing the physical properties of the material, especially its highly anisotropic character, from resulting in structural defects that make correct application of the aforementioned surface ornamentation impossible or deteriorate it once applied, comprising the stages of:

closing the injection machine press,

introducing the thermoplastic material into the spindle device with the desired coloration material,

heating the cylinder of the spindle device to produce the fusion of the introduced material,

rotating the spindle device at a high rate and a low counter-pressure,

leaving the material introduced into the press to cool,

opening the press and subsequently the moulds in its interior, and actuating the ejectors, provided with rotary rollers, in combination with impeller means in the base of the imprint to sweep the pieces outside the press, and

expelling the cold casting pieces.

### OBJECT OF THE INVENTION

The present invention relates to a non-slipping piece of thermoplastic elastomer (TPE), which can be used as a label, publicity support or similar, which provides essential features of novelty and remarkable advantages with respect to the means known and used for the same ends in the current state of the art, as well as to an injection moulding method to produce it.

The field of the invention is comprised between the industrial field dedicated to the manufacture of pieces with application in injection moulding techniques in general and plastic injection in particular.

### BACKGROUND OF THE INVENTION

Currently, there are known thermoplastic elastomers (TPEs) that present great advantage resulting from their non-slip characteristics. However, these non-slip characteristics are reduced or eliminated when the surface of said material receives any type of labelling (silkscreen marking, tampography, etc.) or laminar accessory (sticker or similar), so that its use as a label, publicity support or similar is made more difficult to a certain extent.

On the other hand, and as is well known in general, the current moulding techniques allow pieces to be obtained whose shape corresponds practically to any desired configuration and with the use of a wide diversity of materials, with conforming devices known as moulds.

Nevertheless, these techniques encounter diverse difficulties with certain combinations of moulding method, material to be moulded and the shape of the piece to be obtained, fundamentally derived from the physical characteristics of the material in question.

In fact, the current state of the art highlights these problems when it is desired to confer on a thermoplastic piece suitable features to allow it to be used as a label, due mainly to its high anisotropic character that may lead to distortion or deterioration of the printing, or desynchronisation of the colours.

### SUMMARY OF THE INVENTION

In the case of the present invention, the development of a piece of a specific type of plastic material is proposed, the body being simple, of small dimensions and little thickness, generally flat and obtained with a wide lowered central portion that is used for the provision of ornamentation (either as serigraphic labelling or by the application of a laminar accessory such as a label or similar, as well as the use of an injection method of certain characteristics for its production. Thus, the structure of the piece, the characteristics of the employed material and the form of injection chosen, transfer to the finished piece some properties that allow the aforementioned ornamentation and which provide a non-slipping character which makes it particularly appropriate for use as a label or publicity support stuck to certain types of object, as will be disclosed in greater detail below.

In particular, a first object of the invention consists specifically of a piece moulded with the use of an appropriate material, with preference for the known material SANTOPRENE®, or alternatively EVOPRENE® (a thermoplastic elastomer, in particular, a homopolymer with polypropylene load and rubber, or any other one that is able to provide the piece with the desired features of non-slippage, with a hardness of 5-30 Shore, and so that the piece is of reduced dimensions, but in particular of a thickness that preferably is in the range of 1 mm to 1.5 mm. The piece is generally flat and presents a smooth face, while on the opposite face there is a raised perimeter border, and on the interior part of this border a central portion, lowered with respect to the aforementioned border, this central portion to be used to receive the corresponding ornamentation.

In accordance with the type of material used, the final piece obtained has, as has already been mentioned, non-slipping features that are maintained even on applying the desired ornamentation, thanks to the particular shape of the piece that the aforementioned sector of a certain depth in relation to the surrounding projection has in the interior zone of one of its faces.

Therefore, a second object of the present invention is a moulding method by submarine injection, without use of a roller, through the posterior central part of each imprint of the mould, which makes possible the formation of the already defined thermoplastic part with the appropriate features for its use as a label or publicity support for use with certain surface ornamentation, which consists of the following stages:

closing the injection machine press with a force of approximately 45-55×10⁴ N with moulds of eight imprints in its interior,

introducing the thermoplastic material into the spindle device in the form of chippings through a respective feed shoot at a rate of 24-26 g of load per cycle, with the desired coloration material,

heating the cylinder of the spindle device to approximately 180-230° C. to produce the fusion of the material introduced,

rotating the spindle device at a high rate of 280-330 rpm, with a low counter-pressure of 0-20 bars to carry out the introduction of the material into the press of the injection machine at a flow of 170-190 cm³/sec until filling up the corresponding moulds with a load of 1.3-1.6 g/imprint,

leaving the material introduced into the press to cool for 6-9 sec, as a result of the cooling action of the fluid (mainly water) circulating through the interior of the press at 6-10° C., with a flow of 30-40 L/hour,

opening the press and subsequently the moulds in its interior, and actuating the ejectors in combination with impeller means found in the base of the imprint to sweep the pieces by gravity to a corresponding collection shoot, and

expelling the cold casting pieces.

In this sense, the injection developed is submarine, through the central posterior part of the piece, as a result of the aforementioned anisotropic character of the material, as with a capillary injection the material does not solidify uniformly on cooling and internal forces are created causing creases in the piece and a deterioration in the subsequent ornamentation. Similarly, the method of the invention is carried out using an injection press without rollers with the aim of minimising the possibility of introducing residues of slipping fluid on the pieces which may deteriorate the desired non-slipping features of the piece.

As an additional aspect of the method described above, the final stage is included of applying a layer of adherent material or a double-faced adherent lamina to the smooth face of the piece, along with a detachable protective sheet.

The parameters must be appropriately selected with the aim of preventing the injected pieces from presenting injection defects, such as those known as “shrinkage cracks” or similar defects, and which consist of inappropriate contractions due to unsuitable cooling of the piece.

As can be understood, the characteristics summarised above both for the material and for the mould correspond only to a preferred embodiment and therefore they should not be understood as an exclusive embodiment. In effect, both the materials and the form of construction of the mould could be modified, changed and/or replaced by others that assure that pieces are obtained with the properties of surface finish (soft to the touch) and desired non-slip for the piece of the invention.

### BRIEF DESCRIPTION OF THE DRAWINGS

These and other features and advantages of the invention will be more clearly shown in the following detailed description of a preferred embodiment, given only by way of illustrative example and in no way limiting, with reference to the drawings enclosed with this specification, in which:

FIG. 1 shows schematic plan views, side elevation and longitudinal section views of a piece constructed according to the invention,

FIG. 2 illustrates a schematic plan view of a particular type of mould that could serve as example for its use in the moulding of a piece of the present invention,

FIG. 3 is a block diagram that represents the method of the present invention, developed graphically in correspondence with the corresponding parts of an injection machine represented as a schematic side elevation view.

### DESCRIPTION OF A PREFERRED EMBODIMENT

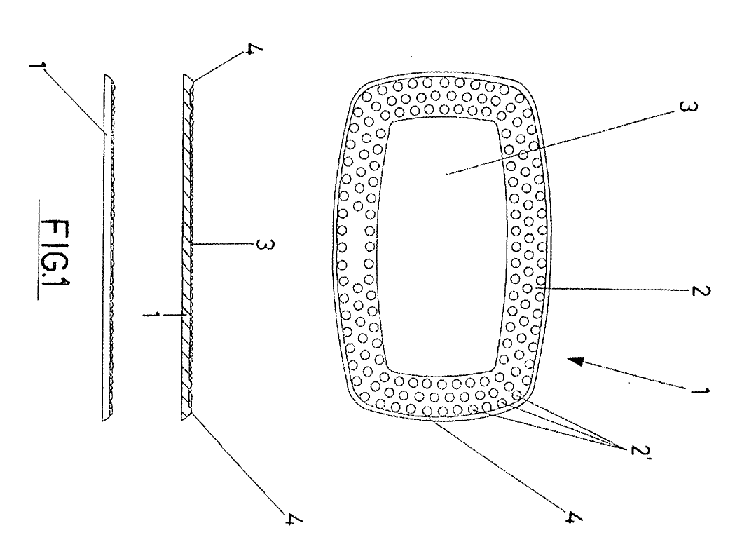

According to an aspect of the present invention, in accordance with that presented in the above, FIG. 1 of the Drawings shows several views of the piece of the invention, on the basis of which the detailed description thereof will be made.

Thus, examining said drawings, it can be seen that the piece that has been indicated with the numerical reference 1 has a base form that is essentially rectangular, preferably around 50 mm by 30 mm, more preferably 47.8 mm by 31 mm, with all sides slightly arched with convexity towards the exterior and with rounded vertices, with a flattened transversal section with very little thickness, preferably of between 1 mm and 1.5 mm, more preferably of 1.4 mm, and bevelled edge 4, preferably with an angle of between 35 and 40 degrees, more preferably of 37 degrees, which produces a larger, smooth, face and a smaller face, in which the formation of a perimeter border 2 can be seen with a uniform thickness, formed by a plurality of elevations 2′, uniformly distributed through the surface of said border 2 and whose height is very small, preferably between 0.2 and 0.5 mm, more preferably around 0.4 mm, which completely surrounds the piece, and through the interior of which a central surface zone 3 is observed, slightly lowered with respect to the upper level of the elevations 2′, preferably around 0.4 mm, more preferably still up to the level of the base of the elevations 2′. Thus, the aforementioned central surface zone 3 constitutes a particularly useful space for the arrangement of any ornamentation (labelling or laminar accessory) since if it were at the same level as the rest of the surface of the piece, the provision of ornamentation would cause the piece to lose its non-slipping properties in said zone, and this would notably reduce its non-slipping properties, which would not be advisable for the foreseen applications.

With specific reference to that seen in the plan view of FIG. 1, the uniform distribution of the elevations 2′ within the perimeter border 2 can be appreciated, as can the central space 3 defined by them. The number of elevations and their dimensions produce a surface of application of preferably at least 30% with relation to the total plan surface of the piece, more preferably of 35%.

Now especially in accordance with the central longitudinal section and side elevation views, respectively, appearing in this same FIG. 1, the small thickness of the piece is perfectly visible as-,well as the edge 4, bevelled towards the shaped face of the piece, and the border 2 formed by the elevations 2′, elevated with respect to the surface central zone 3.

This reduced thickness feature allows the piece to be adhered to certain objects, without obstructing or hindering normal handling thereof. An example of application are mobile telephone terminals in which the piece of the invention can be stuck without making difficult the introduction of the terminal into the corresponding charger and/or other accessories. Other examples include calculators, electronic diaries and, in general, any electronic device.

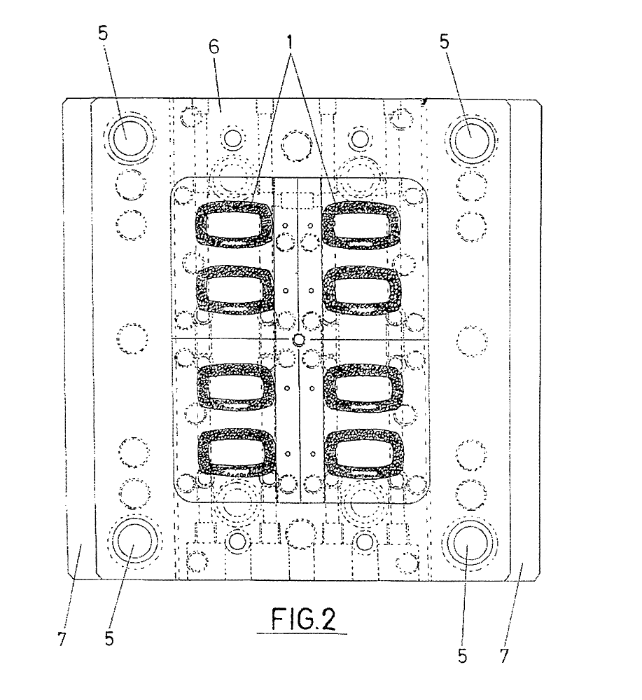

FIG. 2 shows a plan view of an example of a mould usable for the formation of pieces of the invention, showing only the part of the mould supporting the imprints or cavities. In this case, as a preferred embodiment but not an exclusive one, the mould of eight positions has been represented, therefore enabled for simultaneous injection of eight pieces 1, identical to each other, of 1.5 g of load per imprint. The cavities or imprints occupy symmetrical positions with respect to the two axes, and the troughs are not appreciable since they are of the type submerged in the posterior central part of each imprint. The mould has columns 5 at its corners, and the block 6 in which the injection is performed is supported by a plate 7.

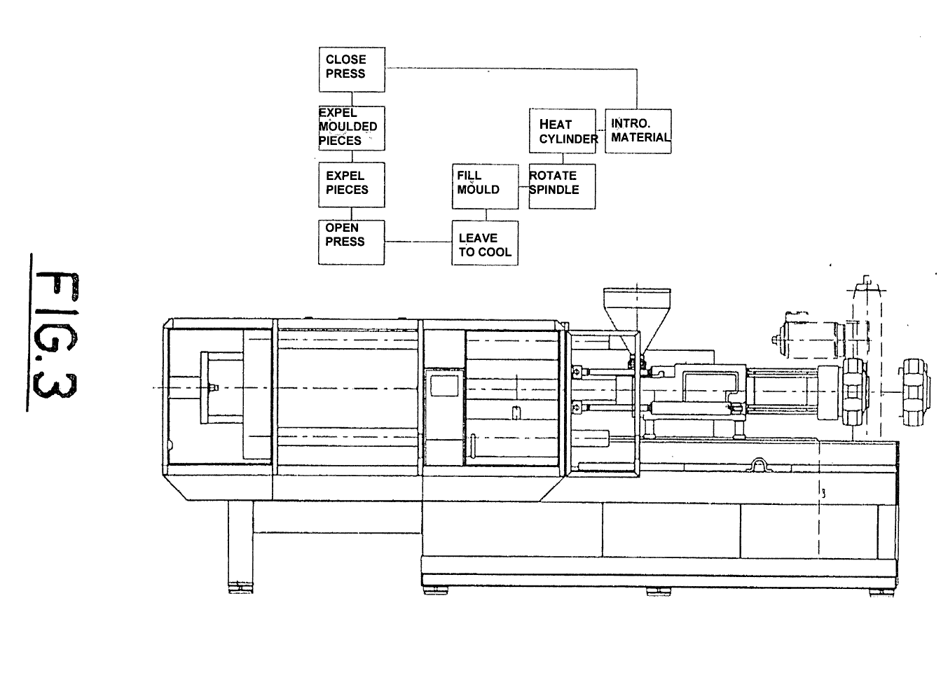

According to a second aspect of the present invention, with reference to FIG. 3, the invention relates to the method of injection moulding for producing the described piece, which is carried out in a Model 60 SANDRETTO SEVEN SERIES injection press without rollers using moulds as shown in FIG. 2, using a thermoplastic material, in particular, a homopolymer with a polypropylene load and rubber, preferably EVOPRENE®, more preferably SANTOPRENE®, with a hardness preferably of 5 Shore, method that consists of the following stages:

closing the press of the injection machine with a force of 49×10⁴ N

introducing the thermoplastic material into the spindle device in the form of chippings through a respective feed shoot at a rate of 25 g of load per cycle,

heating the cylinder of the spindle device to approximately 230° C. to produce the fusion of the introduced material,

rotating the spindle device a 20% of its run at a high velocity of 300 rpm, with a low counter pressure of 5 bar, to perform the introduction of the material into the press of the injection machine until filling the corresponding moulds with a flow of 180 cm³/sec, the load of each imprint being 1.5 g, thus attaining with these parameters a minimum mixing level with a high shearing degree,

leaving the material introduced into the press to cool for 7 sec, as a result of the cooling action of the water circulating through the interior of the press which enters at temperature of 8° C. and leaves at a temperature of 14° C. (circulating in a closed circuit), with a flow rate of 38 L/hour,

opening the press and subsequently the moulds of its interior, and actuating both some impeller means, like mobile male pieces that emerge from the bottom of the imprint until exposing the piece outside the level of the mould, as the ejectors, which incorporate a rotating roller at one end, in the form of a cylindrical brush with an axis of revolution parallel to the plate to “sweep” the pieces from the aforementioned mobile male pieces outside the press, given that the non-slipping character of the pieces prevents them from being swept by conventional ejectors, until the pieces fall by gravity into a corresponding collection shoot, and

expelling the cold casting pieces.

Total cycle time was 15 sec.

The method described above was completed with the application of a layer of adherent material to the smooth face of the piece, specifically, adhesive marketed by Scotch with the commercial reference 9472-LE, and a detachable protective lamina.

It is not considered necessary to extend the content of this description in order that an expert in the art understand the scope and the advantages derived from the invention, as well as to develop and put into practice the object thereof.

Nevertheless, it must be understood that the invention has been described according to a preferred embodiment thereof, and so it may be modified without this supposing an alteration to the scope of said invention, such modifications being possible, in particular, in the shape and size of the piece, and even in the materials used in its manufacture, and also in the features of the mould and the number of positions foreseen therein, as well as slight adjustments to the parameters for combining the material used with materials of desired coloration.

1.- non-slipping piece of thermoplastic elastomer or TPE, usable as a label, publicity support or similar, characterised in that the aforementioned piece (1) consists of a flat body, with an approximately rectangular base, with a bevelled edge (4), body that has a larger smooth face and a smaller opposite face having a perimeter border (2) slightly elevated, of constant thickness, that defines a central surface zone (3) slightly lowered with respect to the upper part of the raised perimeter border (2):

2.- Non-slipping piece according to claim 1, characterised in that the raised perimeter border (2) is subdivided into a series of independent elevations (2′).

3.- Non-slipping piece according to claim 2, characterised in that the central surface (3) is at the same level as the base of the elevations (2′).

4.- Non-slipping piece according to any one of the previous claims, characterised in that thermoplastic elastomer (TPE) material has a hardness between 5 and 30 Shore.

5.- Non-slipping piece according to claim 1, characterised in that the thermoplastic elastomer (TPE) material has a hardness of 5 Shore.

6.- Non-slipping piece according to any one of the previous claims, characterised in that the application surface of the piece is of at least 30% with respect to the total surface of the base of the piece.

7.- Non-slipping piece according to claim 6, characterised in that the application surface of the piece is 35% with respect to the total surface of the base of the piece

8.- Non-slipping piece according to any one of the previous claims, characterised in that the thickness of the piece is between 1 mm. and 1.5 mm.

9.- Non-slipping piece according to claim 8, characterised in that the thickness of the piece is 1.4 mm.

10.- A method for producing a non-slipping piece of thermoplastic elastomer (TPE), according to what is claimed in the previous claims, characterised in that it is carried out by means of submarine injection moulding, without using the roller, and includes the stages of:
closing the injection machine press with a force between 45×10⁴ N and 55×10⁴ N,
introducing the thermoplastic material into the spindle device in the form of chippings through a respective feed shoot at a rate between 24 g and 26 g of load per cycle, with the desired coloration material,
heating the cylinder of the spindle device between 180 and 230° C. to produce the fusion of the introduced material,
rotating the spindle device at a high rate between 280 rpm and 330 rpm, with a low counter-pressure between 0 bar and 20 bars, to perform the introduction of the material into the press of the injection machine at a flow rate between 170 cm³/sec and 190 cm³/sec until filling up the corresponding moulds with a load between 1.3 g/imprint and 1.6 g/imprint,
leaving the material introduced into the press to cool between 6 and 9 sec, and as a result of the cooling action of the fluid circulating through the interior of the press between 6° C. and 10° C., with a flow rate between 30 L/hour and 40 L/hour,
opening the press and subsequently the moulds in its interior, and actuating the ejectors in combination with impeller means in the base of the imprint to sweep the pieces by gravity to a corresponding collection shoot, and
expelling the cold casting pieces.

11.- Method for producing a non-slipping piece of thermoplastic elastomer (TPE), according to claim 10, characterised in that each imprint of the mould is filled with 1.5 g of load.

12.- Method for producing a non-slipping piece of thermoplastic elastomer (TPE), according to any one of claims 10 to 11, characterised in that the force of closure of the press is 49×10⁴ N.

13.- Method for producing a non-slipping piece of thermoplastic elastomer (TPE), according to any of claims 10 to 12, characterised in that the introduction of material into the feed shoot is carried out at a rate of 25 g of load per cycle.

14.- Method for producing a non-slipping piece of thermoplastic elastomer (TPE), according to any of claims 10 to 13, characterised in that the cylinder is heated to 230° C.

15.- Method for producing a non-slipping piece of thermoplastic elastomer (TPE), according to any of claims 10 to 14, characterised in that the spindle device is made to rotate at a high rate of 300 rpm.

16.- Method for producing a non-slipping piece of thermoplastic elastomer (TPE), according to any of claims 10 to 15, characterised in that the spindle device is made to rotate with a low counter-pressure of 5 bar.

17.- Method for producing a non-slipping piece of thermoplastic elastomer (TPE), according to any of claims 10 to 16, characterised in that the injection rate is 160 cm³/sec.

18.- Method for producing a non-slipping piece of thermoplastic elastomer (TPE), according to any of claims 10 to 17, characterised in that the material introduced in the press is left to cool for 7 seconds.

19.- Method for producing a non-slipping piece of thermoplastic elastomer (TPE), according to any of claims 10 to 18, characterised in that the cooling fluid is water that circulates around the interior of the press with an inlet temperature of 8° C. and an outlet temperature of 14° C.

20.- Method for producing a non-slipping piece of thermoplastic elastomer (TPE), according to any of claims 10 to 19, characterised in that cooling water circulates around the interior of the press at a flow rate of 38 L/hour.

21.- Method for producing a non-slipping piece of thermoplastic elastomer (TPE), according to any of claims 10 to 20, characterised in that it is carried out with cold castings.

22.- Method for producing a non-slipping piece of thermoplastic elastomer (TPE), according to any of claims 10 to 21, characterised in that on opening the press, and as a result the moulds of its interior, some impeller means are actuated, consisting of male mobile pieces that emerge from the bottom of the imprint until exposing the piece beyond the level of the mould.

23.- Method for producing a non-slipping piece of thermoplastic elastomer (TPE), according to any of claims 10 to 22, characterised in that on opening the press, and as a result the moulds of its interior, some ejection means are actuated which incorporate a rotating roller at their end consisting of a cylindrical brush with an axis of revolution parallel to the plate, to “sweep” the pieces until they fall by gravity into the corresponding collection shoot.

24.- Method for producing a non-slipping piece of thermoplastic elastomer (TPE), according to any of claims 10 to 23, characterised in that the total cycle time is 15 seconds.

25.- Method for producing a non-slipping piece of thermoplastic elastomer (TPE), according to claims 10, 15, 16 or 17, characterised in that the combination of the parameters of rate of rotation of the spindle, the counter-pressure of the spindle and the rate of injection lead to a low mixing level and a high shearing level.

26.- Method for producing a non-slipping piece of thermoplastic elastomer (TPE), according to any of claims 10 to 25, characterised in that there is an additional stage of incorporating a layer of material adherent to the smooth surface of the produced piece, and a detachable sheet of coating over said lamina.

24.- Method for producing a non-slipping piece of thermoplastic elastomer (TPE), according to any one of claims 10 to 25, characterised in that there is an additional stage of incorporating of a double-layer adherent lamina to the smooth surface of the piece produced, and a detachable sheet of coating over said lamina.
